(19) United States
(12) Patent Application Publication
(10) Pub. No.: US 2012/0144104 A1
(43) Pub. Date: Jun. 7, 2012

(54) Partitioning of Memory Device for Multi-Client Computing System

(75) Inventors: Thomas J. GIBNEY, Newton, MA (US); Patrick J. Koran, Hollis, NH (US)

(73) Assignee: Advanced Micro Devices, Inc., Sunnyvale, CA (US)

(21) Appl. No.: 12/958,748

(22) Filed: Dec. 2, 2010

(51) Int. Cl. G06F 12/14; G06F 12/00

(52) U.S. Cl. 711/105; 711/163; 711/E12.091; 711/E12.001

(57) ABSTRACT

A method, computer program product, and system are provided for accessing a memory device. For instance, the method can include partitioning one or more memory banks of the memory device into a first and a second set of memory banks. The method also can allocate a first plurality of memory cells within the first set of memory banks to a first memory operation of a first client device and a second plurality of memory cells within the second set of memory banks to a second memory operation of a second client device. This memory allocation can allow access to the first and second sets of memory banks when a first and a second memory operation are requested by the first and second client devices, respectively. Further, access to a data bus between the first client device, or the second client device, and the memory device can also be controlled based on whether the first memory address or the second memory address is accessed to execute the first or second memory operation.

### BACKGROUND

1. Field

Embodiments of the present invention generally relate to partitioning of a memory device for a multi-client computing system.

2. Background

Due to the demand for increasing processing speed and volume, many computing systems employ multiple client devices (also referred to herein as “computing devices”) such as central processing units (CPUs), graphics processing units (GPUs), or a combination thereof. In computer systems with multiple client devices (also referred to herein as a “multi-client computing system”) and a unified memory architecture (UMA), each of the client devices share access to one or more memory devices in the UMA. This communication can occur via a data bus routed from a memory controller to each of the memory devices and a common system bus routed from the memory controller to the multiple client devices.

For multi-client computing systems, the UMA typically results in lower system cost and power versus alternative memory architectures. The cost is reduced due to fewer memory chips (e.g., Dynamic Random Access Memory (DRAM) devices) and also due to a lower number of input/output (I/O) interfaces connecting the computing devices and the memory chips. These factors also result in lower power for the UMA since power overhead associated with memory chips and I/O interfaces is reduced. In addition, power-consuming data copy operations between memory interfaces are eliminated in the UMA, whereas other memory architectures may require these power-consuming operations.

However, there is a source of inefficiency related to a recovery time of the memory device, in which this recovery time may be increased in a multi-client computing system with a UMA. The recovery time period occurs when one or more client devices request successive data transfers from the same memory bank of the memory device (also referred to herein as “memory bank contention”). The recovery time period refers to a delay time exhibited by the memory device between a first access and an immediate second access to the memory device. That is, while the memory device accesses data, no data can be transferred on the data or system buses during the recovery time period, thus leading to inefficiency in the multi-client computing system. Furthermore, as processing speeds have increased in multi-client computing systems over time, the recovery time period for typical memory devices has not kept pace, resulting in an ever-increasing memory performance gap.

Methods and systems are needed, therefore, to reduce, or eliminate the inefficiencies related to memory bank contention in multi-client computing systems.

### SUMMARY

Embodiments of the present invention include a method for accessing a memory device in a computer system with a plurality of client devices. The method can include the following: partitioning one or more memory banks of the memory device into a first set of memory banks and a second set of memory banks; allocating a first plurality of memory cells within the first set of memory banks to a first memory operation associated with a first client device; allocating a second plurality of memory cells within the second set of memory banks to a second memory operation associated with a second client device; accessing, via a data bus coupling the first and second client devices to the memory device, the first set of memory banks when the first memory operation is requested by the first client device, where a first memory address from the first set of memory banks is associated with the first memory operation; accessing, via the data bus, the second set of memory banks when the second memory operation is requested by the second client device, where a second memory address from the second set of memory banks is associated with the second memory operation; and, providing control of the data bus to the first client device or the second client device during the first memory operation or second memory operation, respectively, based on whether the first memory address or the second memory address is accessed to execute the first or second memory operation.

Embodiments of the present invention additionally include a computer program product that includes a computer-usable medium having computer program logic recorded thereon for enabling a processor to access a memory device in a computer system with a plurality of client devices. The computer program logic can include the following: first computer readable program code that enables a processor to partition one or more memory banks of the memory device into a first set of memory banks and a second set of memory banks; second computer readable program code that enables a processor to allocate a first plurality of memory cells within the first set of memory banks to a first memory operation associated with a first client device; third computer readable program code that enables a processor to allocate a second plurality of memory cells within the second set of memory banks to a second memory operation associated with a second client device; fourth computer readable program code that enables a processor to access, via a data bus coupling the first and second client devices to the memory device, the first set of memory banks when the first memory operation is requested by the first client device, where a first memory address from the first set of memory banks is associated with the first memory operation; fifth computer readable program code that enables a processor to access, via the data bus, the second set of memory banks when the second memory operation is requested by the second client device, where a second memory address from the second set of memory banks is associated with the second memory operation; and, sixth computer readable program code that enables a processor to provide control of the data bus to the first client device or the second client device during the first memory operation or second memory operation, respectively, based on whether the first memory address or the second memory address is accessed to execute the first or second memory operation.

Embodiments of the present invention also include a computer system. The computer system can include a first client device, a second client device, a memory device, and a memory controller. The memory device can include one or more memory banks partitioned into a first set of memory banks and a second set of memory banks. A first plurality of memory cells within the first set of memory banks can be allocated to a first memory operation associated with the first client device. Similarly, a second plurality of memory cells within the second set of memory banks can be allocated to a second memory operation associated with the second client device. Further, the memory controller can be configured to perform the following functions: control access between the first client device and the first set of memory banks, via a data bus coupling the first and second client devices to the memory device, when the first memory operation is requested by the first client device, where a first memory address from the first set of memory banks is associated with the first memory operation; control access between the second client device and the second set of memory banks, via the data bus, when the second memory operation is requested by the second client device, where a second memory address from the second set of memory banks is associated with the second memory operation; and, provide control of the data bus to the first client device or the second client device during the first memory operation or second memory operation, respectively, based on whether the first memory address or the second memory address is accessed to execute the first or second memory operation.

Further features and advantages of the invention, as well as the structure and operation of various embodiments of the present invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art based on the teachings contained herein.

### BRIEF DESCRIPTION OF THE DRAWINGS

The accompanying drawings, which are incorporated herein and form a part of the specification, illustrate embodiments of the present invention and, together with the description, further serve to explain the principles of the invention and to enable a person skilled in the relevant art to make and use the invention.

FIG. 1 is an illustration of an embodiment of a multi-client computing system with a unified memory architecture (UMA).

FIG. 2 is an illustration of an embodiment of a memory controller.

FIG. 3 is an illustration of an embodiment of a memory device with partitioned memory banks.

FIG. 4 is an illustration of an example interleaved arrangement of CPU- and GPU-related memory requests performed by a memory scheduler.

FIG. 5 is an illustration of an embodiment of a method of accessing a memory device in a multi-client computing system.

FIG. 6 is an illustration of an example computer system in which embodiments of the present invention can be implemented.

### DETAILED DESCRIPTION

The following detailed description refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

It would be apparent to a person skilled in the relevant art that the present invention, as described below, can be implemented in many different embodiments of software, hardware, firmware, and/or the entities illustrated in the figures. Thus, the operational behavior of embodiments of the present invention will be described with the understanding that modifications and variations of the embodiments are possible, given the level of detail presented herein.

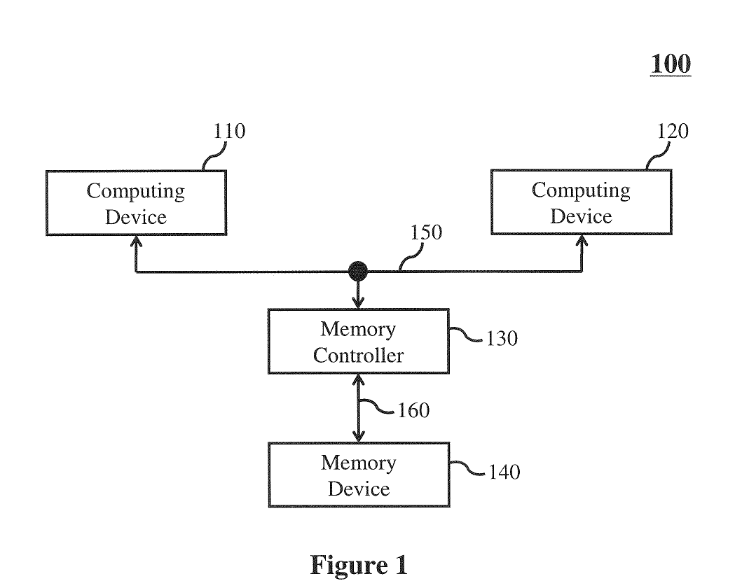

FIG. 1 is an illustration of an embodiment of a multi-client computing system 100 with a unified memory architecture (UMA). Multi-client computing system 100 includes a first computing device 110, a second computing device 120, a memory controller 130, and a memory device 140. First and second computing devices 110 and 120 are communicatively coupled to memory controller 130 via a system bus 150. Also, memory controller 130 is communicatively coupled to memory device 140 via a data bus 160.

A person skilled in the relevant art will recognize that multi-client computing system 100 with the UMA illustrates an abstract view of the devices contained therein. For instance, with respect to memory device 140, a person skilled in the relevant art will recognize that the UMA can be arranged as a “single-rank” configuration, in which memory device 140 can represent a row of memory devices (e.g., DRAM devices). Further, with respect to memory device 140, a person skilled in the relevant art will also recognize that the UMA can be arranged as a “multi-rank” configuration, in which memory device 140 can represent multiple rows of memory devices attached to data bus 160. In the single-rank and multi-rank configurations, memory controller 130 can be configured to control access to the memory banks of the memory devices. A benefit, among others, of the single-rank and multi-rank configurations is that flexibility in the partitioning of memory banks among computing devices 110 and 120 can be achieved.

Based on the description herein, a person skilled in the relevant art will recognize that multi-client computing system 100 can include more than two computing devices, more than one memory controller, more than one memory device, or a combination thereof. These different configurations of multi-client computing system 100 are within the scope and spirit of the embodiments described herein. However, for ease of explanation, the embodiments contained herein will be described in the context of the system architecture depicted in FIG. 1.

In an embodiment, each of computing devices 110 and 120 can be, for example and without limitation, a central processing unit (CPU), a graphics processing unit (GPU), an application-specific integrated circuit (ASIC) controller, other similar types of processing units, or a combination thereof Computing devices 110 and 120 are configured to execute instructions and to carry out operations associated with multi-client computing system 100. For instance, multi-client computing system 100 can be configured to render and display graphics. Multi-client computing system 100 can include a CPU (e.g., computing device 110) and a GPU (e.g., computing device 120), where the GPU can be configured to render two- and three-dimensional graphics and the CPU can be configured to coordinate the display of the rendered graphics onto a display device (not shown in FIG. 1).

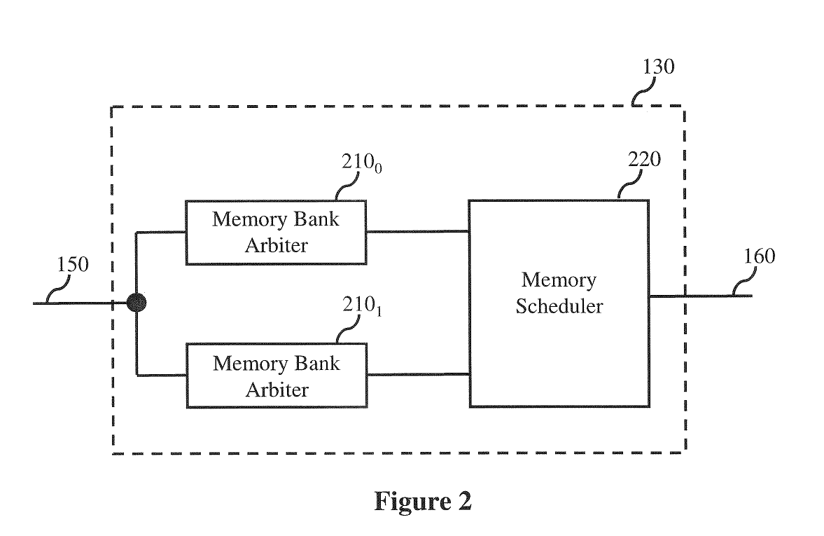

When executing instructions and carrying out operations associated with multi-client computing system 100, computing devices 110 and 120 can access information stored in memory device 140 via memory controller 130. FIG. 2 is an illustration of an embodiment of memory controller 130. Memory controller 130 includes a first memory bank arbiter 210₀, a second memory bank arbiter 210₁, and a memory scheduler 220.

In an embodiment, first memory bank arbiter 210₀ is configured to sort requests to a first set of memory banks of a memory device (e.g., memory device 140 of FIG. 1). In a similar manner, second memory bank arbiter 210₁ is configured to sort requests to a second set of memory banks of the memory device (e.g., memory device 140 of FIG. 1). As understood by a person skilled in the relevant art, first and second memory bank arbiters 210₀ and 210₁ are configured to prioritize memory requests (e.g., read and write operations) from a computing device (e.g., computing devices 110 and 120). A set of memory addresses from computing device 110 can be allocated to the first set of memory banks, resulting in being processed by first memory bank arbiter 210₀. Similarly, a set of memory addresses from computing device 120 can be allocated to the second set of memory banks, resulting in being processed by second memory bank arbiter 210₁.

In reference to FIG. 2, memory scheduler 220 is configured to process the sorted memory requests from first and second memory bank arbiters 210₀ and 210₁. In an embodiment, memory scheduler 220 processes the sorted memory requests in rounds in a manner that optimizes read and write efficiency and maximizes the bandwidth on data bus 160 of FIG. 1. In an embodiment, data bus 160 has a predetermined bus width, in which transfer of data to and from memory device 140 to computing devices 110 and 120 uses the entire bus width of data bus 160.

Memory scheduler 220 of FIG. 2 may minimize conflicts with memory banks in memory device 140 by sorting, re-ordering, and clustering memory requests to avoid back-to-back requests of different rows in the same memory bank. In an embodiment, memory scheduler 220 can prioritize its processing of the sorted memory requests based on the computing device making the request. For instance, memory scheduler 220 may process the sorted memory requests from first memory bank arbiter 210₀ (e.g., corresponding to a set of address requests from computing device 110) before processing the sorted memory requests (e.g., corresponding to a set of address requests from computing device 120), or vice versa. As understood by a person skilled in the relevant art, the output of memory scheduler 220 is processed to produce address, command, and control signals necessary to send read and write requests to memory device 140 via data bus 160 of FIG. 1. The generation of address, command, and control signals corresponding to read and write memory requests is known to persons skilled in the relevant art.

In reference to FIG. 1, memory device 140 is a Dynamic Random Access Memory (DRAM) device, according to an embodiment of the present invention. Memory device 140 is partitioned into a first set of memory banks and a second set of memory banks. One or more memory cells in the first set of memory banks is allocated to a first plurality of memory buffers associated with operations of computing device 110. Similarly, one or more memory cells in the second set of memory banks is allocated to a second plurality of memory buffers associated with operations of computing device 120.

For simplicity and explanation purposes, the following discussion assumes that memory device 140 is partitioned into two sets of memory banks—a first set of memory banks and a second set of memory banks. However, based on the description herein, a person skilled in the relevant art will recognize that memory device 140 can be partitioned into more than two sets of memory banks (e.g., three sets of memory banks, four sets of memory banks, five sets of memory banks, etc.), in which each of the sets of memory banks can be allocated to a particular computing device. For instance, if memory device 140 is partitioned into three sets of memory banks, one memory bank can be allocated to computing device 110, one memory bank can be allocated to computing device 120, and the third memory bank can be allocated to a third computing device (not depicted in multi-client computing system 100 of FIG. 1).

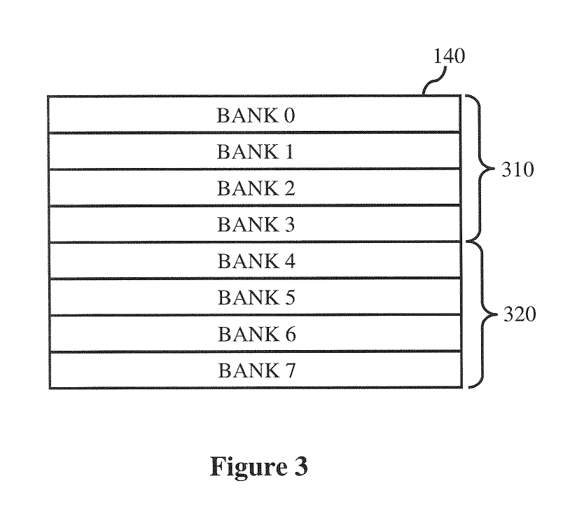

FIG. 3 is an illustration of an embodiment of memory device 140 with a first set of memory banks 310 and a second set of memory banks 320. As depicted in FIG. 3, memory device 140 contains 8 memory banks, in which 4 of the memory banks is allocated to first set of memory banks 310 (e.g., memory banks 0-3) and 4 of the memory banks is allocated to second set of memory banks 320 (e.g., memory banks 4-7). Based on the description herein, a person skilled in the relevant art will recognize that memory device 140 can contain more or less than 8 memory banks (e.g., 4 and 16 memory banks), and that the memory banks of memory device 140 can be partitioned into different arrangements such as, for example and without limitation, 6 memory banks allocated to first set of memory banks 310 and 2 memory banks allocated to second set of memory banks 320.

First set of memory banks 310 corresponds to a lower set of addresses and second set of memory banks 320 corresponds to an upper set of addresses. For instance, if memory device 140 is a two gigabyte (GB) memory device with 8 banks, then the memory addresses corresponding to 0-1 GBs is allocated to first set of memory banks 310 and the memory addresses corresponding to 1-2 GBs is allocated to second set of memory banks 320. Based on the description herein, a person skilled in the relevant art will recognize that memory device 140 can have a smaller or larger memory capacity than two GBs. These other memory capacities for memory device 140 are within the spirit and scope of the embodiments described herein.

First set of memory banks 310 is associated with operations of computing device 110. Similarly, second set of memory banks 320 is associated with operations of computing device 320. For instance, as would be understood by a person skilled in the relevant art, memory buffers are typically used when moving data between operations or processes executed by computing devices (e.g., computing devices 110 and 120).

As noted above, computing device 110 can be a CPU, with first set of memory banks 310 being allocated to memory buffers used in the execution of operations by CPU computing device 110. Memory buffers required to execute latency-sensitive CPU instruction code can be mapped to one or more memory cells in first set of memory banks 310. A benefit, among others, of mapping the latency-sensitive CPU instruction code to first set of memory banks 310 is that memory bank contention issues can be reduced, or avoided, between computing devices 110 and 120.

Computing device 120 can be a GPU, with second set of memory banks 320 being allocated to memory buffers used in the execution of operations by GPU computing device 120. Frame memory buffers required to execute graphics operations can be mapped to one or more memory cells in second set of memory banks 320. Since one or more memory regions of memory device 140 are dedicated to GPU operations, a benefit, among others, of second set of memory banks 320 is that memory bank contention issues can be reduced, or avoided, between computing devices 110 and 120.

As described above with respect to FIG. 2, first memory bank arbiter 210₀ can have addresses that are allocated by computing device 110 and directed to first set of memory banks 310 of FIG. 3. In the above example in which computing device 110 is a CPU, the arbitration for computing device 110 can be optimized using techniques such as, for example and without limitation, predictive page open policies and address pre-fetching in order to efficiently execute latency-sensitive CPU instruction code, according to an embodiment of the present invention.

Similarly, second memory bank arbiter 210₁ can have addresses that are allocated by computing device 120 and directed to second set of memory banks 320 of FIG. 3. In the above example in which computing device 120 is a GPU, the thread for computing device 120 can be optimized for maximum bandwidth, according to an embodiment of the present invention.

Once first memory bank arbiter 210₀ sorts each of the threads of arbitration for memory requests from computing devices 110 and 120, memory scheduler 220 of FIG. 2 processes the sorted memory requests. With respect to the example above, in which computing device 110 is a CPU and computing device 120 is a GPU, scheduler 220 can be optimized by processing CPU-related memory requests before GPU-related memory requests. This process is possible since CPU performance is typically more sensitive to memory delay than GPU performance, according to an embodiment of the present invention. Here, memory scheduler 220 provides control of data bus 160 to computing device 110 such that the data transfer associated with the CPU-related memory request takes priority over the data transfer associated with the GPU-related memory request.

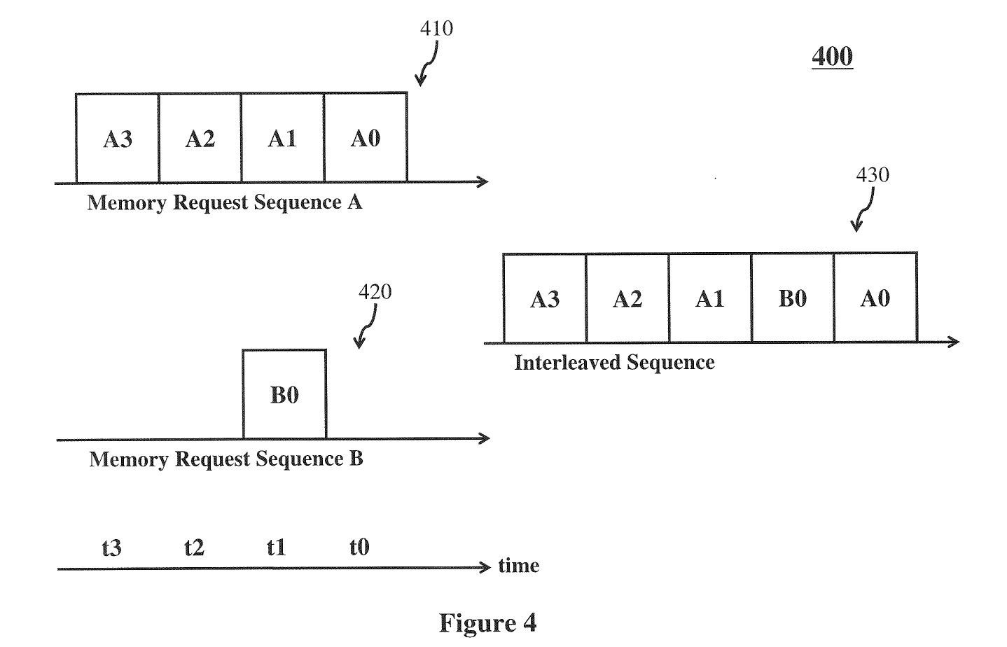

In another embodiment, GPU-related memory requests (e.g., from computing device 120 of FIG. 1) can be interleaved before and/or after CPU-related memory requests (e.g., from computing device 110). FIG. 4 is an illustration of an example interleaved arrangement 400 of CPU- and GPU-related memory requests performed by memory scheduler 220. In interleave arrangement 400, if a CPU-related memory request (e.g., a memory request sequence 420) is sent while a GPU-related memory request (e.g., a memory request sequence 410) is being processed, memory scheduler 220 can be configured to halt the data transfer related to the GPU-related memory request in favor of the data transfer related to the CPU-related memory request on data bus 160. Memory scheduler 220 can be configured to continue the data transfer related to the GPU-related memory request on data bus 160 immediately after the CPU-related memory request is issued. The resulting interleaved arrangement of both CPU- and GPU-related memory requests is depicted in an interleaved sequence 430 of FIG. 4.

In referring to interleaved sequence 430 of FIG. 4, this is an example of how CPU and GPU-related memory requests can be optimized in the sense that the CPU-related memory request is interleaved into the GPU-related memory request stream. As a result, the CPU-related memory request is processed with minimal latency, and the GPU-related memory request stream is interrupted for a minimal time necessary to service the CPU-related memory request. There is no overhead due to memory bank conflicts since the CPU- and GPU-related memory request streams are guaranteed not to conflict with one another.

With respect to the example in which computing device 110 is a CPU and computing device 120 is a GPU, memory buffers for all CPU operations associated with computing device 110 can be allocated to one or more memory cells in first set of memory banks 310. Similarly, memory buffers for all GPU operations associated with computing device 120 can be allocated to one or more memory cells in second set of memory banks 320.

Alternatively, memory buffers for CPU operations and memory buffers for GPU operations can be allocated to one or more memory cells in both first and second sets of memory banks 310 and 320, respectively, according to an embodiment of the present invention. For instance, memory buffers for latency-sensitive CPU instruction code can be allocated to one or more memory cells in first set of memory banks 310 and memory buffers for non-latency sensitive CPU operations can be allocated to one or more memory cells in second set of memory banks 320.

For data that is shared between computing devices (e.g., computing device 110 and computing device 120), the shared memory addresses can be allocated to one or more memory cells in either first set of memory banks 310 or second set of memory banks 320. In this case, memory requests from both of the computing devices will be arbitrated in a single memory bank arbiter (e.g., first memory bank arbiter 210₀ or second memory bank arbiter 210₁). This arbitration by the single memory bank arbiter can result in a performance impact in comparison to independent arbitration performed for each of the computing devices. However, as long as shared data is a low proportion of the overall memory traffic, the shared data allocation can result in little diminishment in the overall performance gains achieved by separate memory bank arbiters for each of the computing devices (e.g., first memory bank arbiter 210₀ associated with computing device 110 and second memory bank arbiter 210₁ associated with computing device 120).

In view of the above-described embodiments of multi-client computing system 100 with the UMA of FIG. 1, many benefits are realized with dedicated memory partitions allocated to each of the client devices in multi-client computing system 100 (e.g., first and second sets of memory banks 310 and 320). For example, the memory banks of memory device 140 can be separated, and separate memory banks for computing devices 110 and 120 can be allocated. In this manner, a focused tuning of bank page policies can be achieved to meet the individual needs of computing devices 110 and 120. This results in fewer memory bank conflicts per memory request. In turn, this can lead to performance gains and/or power savings in multi-client computing system 100.

In another example, as a result of reduced or zero bank contention between computing devices 110 and 120, latency can be better predicted. This enhanced prediction can be achieved without a significant bandwidth performance penalty in multi-client computing system 100 due to prematurely closing a memory bank sought to be opened by another computing device. That is, multi-client computing systems typically close a memory bank of a lower-priority computing device (e.g., GPU) to service a higher-priority low-latency computing device (e.g., CPU) at the expense of the overall system bandwidth. In the embodiments described above, the memory banks allocated to memory buffers for computing device 110 do not interfere with the memory banks allocated to memory buffers for computing device 120.

In yet another example, another benefit of the above-described embodiments of multi-client computing system is scalability. As the number of computing devices in multi-client computing system 100 and the number of memory banks in memory device 140 both increase, multi-client computing system 100 can simply be scaled. Scaling can be accomplished by appropriately partitioning memory device 140 into sets of one or more memory banks allocated to each of the computing devices. For instance, as understood by a person skilled in the relevant art, DRAM memory bank growth has grown from 4 memory banks, to 8 memory banks, to 16 memory banks, and continues to grow. These memory banks can be appropriately partitioned and allocated to each of the computing devices in multi-client computing system 100 as the number of client devices increase.

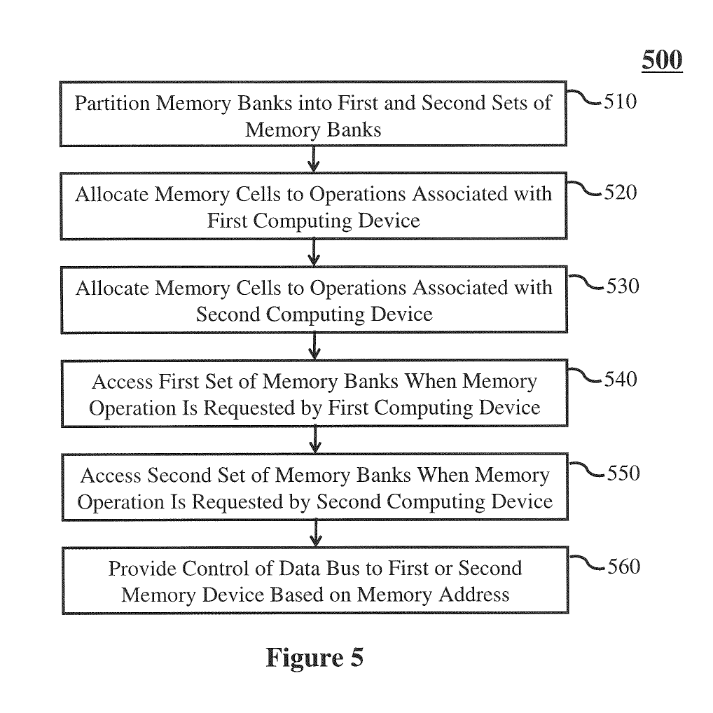

FIG. 5 is an illustration of an embodiment of a method 500 for accessing a memory device in a multi-client computing system. Method 500 can occur using, for example and without limitation, multi-client computing system 100 of FIG. 1.

In step 510, one or more memory banks of the memory device is partitioned into a first set of memory banks and a second set of memory banks. In an embodiment, the memory device is a DRAM device with an upper-half plurality of memory banks (e.g., memory banks 0-3 of FIG. 3) and a lower-half plurality of memory banks (e.g., memory banks 4-7 of FIG. 3). The partitioning of the one or more banks of the memory device can include associating (e.g., mapping) the first set of memory banks with the upper-half plurality of memory banks in the DRAM device and associating (e.g., mapping) the second set of memory banks with the lower half of memory banks in the DRAM device.

In step 520, a first plurality of memory cells within the first set of memory banks is allocated to memory operations associated with a first client device (e.g., computing device 110 of FIG. 1). Allocation of the first plurality of memory cells includes mapping one or more physical address spaces within the first set of memory banks to respective memory operations associated with the first client device (e.g., first set of memory banks 310 of FIG. 3). For instance, if the memory device is a 2 GB DRAM device with 8 memory banks, then 4 memory banks can be allocated to the first set of memory banks, in which memory addresses corresponding to 0-1 GBs can be associated with (e.g., mapped to) the 4 memory banks.

In step 530, a second plurality of memory cells within the second set of memory banks is allocated to memory operations associated with a second client device (e.g., computing device 120 of FIG. 1). Allocation of the second plurality of memory cells includes mapping one or more physical address spaces within the second set of memory banks to respective memory operations associated with the second client device (e.g., second set of memory banks 320 of FIG. 3). For instance, with respect to the example in which the memory device is a 2 GB DRAM device with 8 memory banks, then 4 memory banks can be allocated (e.g., mapped) to the second set of memory banks. Here, memory addresses corresponding to 1-2 GBs can be associated with (e.g., mapped to) the 4 memory banks.

In step 540, the first set of memory banks is accessed when a first memory operation is requested by the first client device, where a first memory address from the first set of memory banks is associated with the first memory operation. The first set of memory banks can be accessed via a data bus that couples the first and second client devices to the memory device (e.g., data bus 160 of FIG. 1). The data bus has a predetermined bus width, in which data transfer between the first client device, or the second client device, and the memory device uses the entire bus width of the data bus.

In step 550, the second set of memory banks is accessed when a second memory operation is requested by the second client device, where a second memory address from the second set of memory banks is associated with the second memory operation. Similar to step 540, the second set of memory banks can be accessed via the data bus.

In step 560, control of the data bus is provided to the first client device or the second client device during the first memory operation or the second memory operation, respectively, based on whether the first memory address or the second memory address is accessed to execute the first or second memory operation. If a first memory operation request occurs after a second memory operation request and if the first memory address is required to be accessed to execute the first memory operation, then control of the data bus is relinquished from the second client device in favor of control of the data bus to the first client device. Control of the data bus to the second client device can be re-established after the first memory operation is complete, according to an embodiment of the present invention.

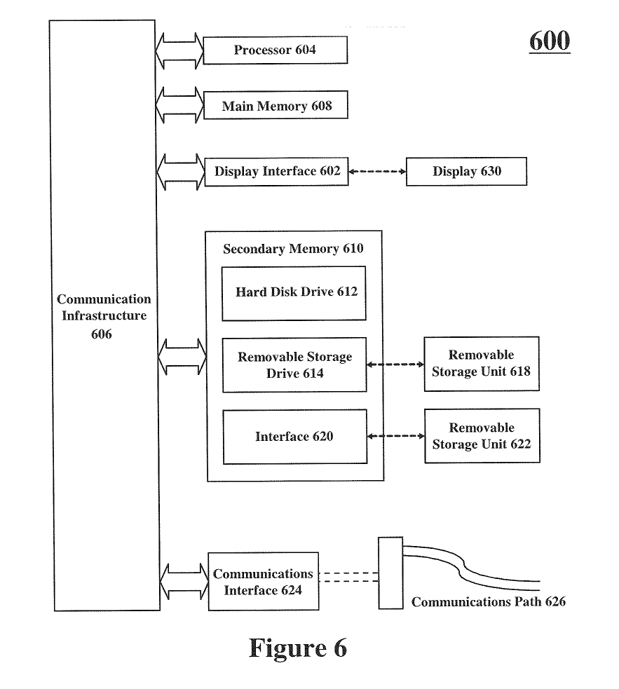

Various aspects of the present invention may be implemented in software, firmware, hardware, or a combination thereof. FIG. 6 is an illustration of an example computer system 600 in which embodiments of the present invention, or portions thereof, can be implemented as computer-readable code. For example, the method illustrated by flowchart 500 of FIG. 5 can be implemented in system 600. Various embodiments of the present invention are described in terms of this example computer system 600. After reading this description, it will become apparent to a person skilled in the relevant art how to implement embodiments of the present invention using other computer systems and/or computer architectures.

It should be noted that the simulation, synthesis and/or manufacture of various embodiments of this invention may be accomplished, in part, through the use of computer readable code, including general programming languages (such as C or C++), hardware description languages (HDL) such as, for example, Verilog HDL, VHDL, Altera HDL (AHDL), or other available programming and/or schematic capture tools (such as circuit capture tools). This computer readable code can be disposed in any known computer-usable medium including a semiconductor, magnetic disk, optical disk (such as CD-ROM, DVD-ROM). As such, the code can be transmitted over communication networks including the Internet. It is understood that the functions accomplished and/or structure provided by the systems and techniques described above can be represented in a core (such as a GPU core) that is embodied in program code and can be transformed to hardware as part of the production of integrated circuits.

Computer system 600 includes one or more processors, such as processor 604. Processor 604 may be a special purpose or a general purpose processor. Processor 604 is connected to a communication infrastructure 606 (e.g., a bus or network).

Computer system 600 also includes a main memory 1608, preferably random access memory (RAM), and may also include a secondary memory 610. Secondary memory 610 can include, for example, a hard disk drive 612, a removable storage drive 614, and/or a memory stick. Removable storage drive 614 can include a floppy disk drive, a magnetic tape drive, an optical disk drive, a flash memory, or the like. The removable storage drive 614 reads from and/or writes to a removable storage unit 618 in a well known manner. Removable storage unit 618 can comprise a floppy disk, magnetic tape, optical disk, etc. which is read by and written to by removable storage drive 614. As will be appreciated by persons skilled in the relevant art, removable storage unit 618 includes a computer-usable storage medium having stored therein computer software and/or data.

In alternative implementations, secondary memory 610 can include other similar devices for allowing computer programs or other instructions to be loaded into computer system 600. Such devices can include, for example, a removable storage unit 622 and an interface 620. Examples of such devices can include a program cartridge and cartridge interface (such as those found in video game devices), a removable memory chip (e.g., EPROM or PROM) and associated socket, and other removable storage units 622 and interfaces 620 which allow software and data to be transferred from the removable storage unit 622 to computer system 600.

Computer system 600 can also include a communications interface 624. Communications interface 624 allows software and data to be transferred between computer system 600 and external devices. Communications interface 624 can include a modem, a network interface (such as an Ethernet card), a communications port, a PCMCIA slot and card, or the like. Software and data transferred via communications interface 624 are in the form of signals which may be electronic, electromagnetic, optical, or other signals capable of being received by communications interface 624. These signals are provided to communications interface 624 via a communications path 626. Communications path 626 carries signals and can be implemented using wire or cable, fiber optics, a phone line, a cellular phone link, a RF link or other communications channels.

In this document, the terms “computer program medium” and “computer-usable medium” are used to generally refer to media such as removable storage unit 618, removable storage unit 622, and a hard disk installed in hard disk drive 612. Computer program medium and computer-usable medium can also refer to memories, such as main memory 608 and secondary memory 610, which can be memory semiconductors (e.g., DRAMs, etc.). These computer program products provide software to computer system 600.

Computer programs (also called computer control logic) are stored in main memory 608 and/or secondary memory 610. Computer programs may also be received via communications interface 624. Such computer programs, when executed, enable computer system 600 to implement embodiments of the present invention as discussed herein. In particular, the computer programs, when executed, enable processor 604 to implement processes of embodiments of the present invention, such as the steps in the methods illustrated by flowchart 500 of FIG. 5, discussed above. Accordingly, such computer programs represent controllers of the computer system 600. Where embodiments of the present invention are implemented using software, the software can be stored in a computer program product and loaded into computer system 600 using removable storage drive 614, interface 620, hard drive 612, or communications interface 624.

Embodiments of the present invention are also directed to computer program products including software stored on any computer-usable medium. Such software, when executed in one or more data processing device, causes a data processing device(s) to operate as described herein. Embodiments of the present invention employ any computer-usable or -readable medium, known now or in the future. Examples of computer-usable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage devices, etc.), and communication mediums (e.g., wired and wireless communications networks, local area networks, wide area networks, intranets, etc.).

While various embodiments of the present invention have been described above, it should be understood that they have been presented by way of example only, and not limitation. It will be understood by persons skilled in the relevant art that various changes in form and details can be made therein without departing from the spirit and scope of the invention as defined in the appended claims. It should be understood that the invention is not limited to these examples. The invention is applicable to any elements operating as described herein. Accordingly, the breadth and scope of the present invention should not be limited by any of the above-described exemplary embodiments, but should be defined only in accordance with the following claims and their equivalents.

What is claimed is:

1. A method for accessing a memory device in a multi-client computing system, the method comprising:
partitioning one or more memory banks of the memory device into a first set of memory banks and a second set of memory banks;
configuring access to a first plurality of memory cells within the first set of memory banks, wherein the first plurality of memory cells is associated with a first memory operation of a first client device; and
configuring access to a second plurality of memory cells within the second set of memory banks, wherein the second plurality of memory cells is associated with a second memory operation of a second client device.

2. The method of claim 1, further comprising:
accessing, via a data bus coupling the first and second client devices to the memory device, the first set of memory banks when the first memory operation is requested by the first client device, wherein a first memory address from the first set of memory banks is associated with the first memory operation;
accessing, via the data bus, the second set of memory banks when the second memory operation is requested by the second client device, wherein a second memory address from the second set of memory banks is associated with the second memory operation; and
providing control of the data bus to the first client device or the second client device during the first memory operation or second memory operation, respectively, based on whether the first memory address or the second memory address is accessed to execute the first or second memory operation.

3. The method of claim 2, wherein the data bus has a predetermined bus width, and wherein the providing control of the data bus comprises transferring data between the first client device, or the second client device, and the memory device using the entire bus width of the data bus.

4. The method of claim 2, wherein the providing control of the data bus comprises providing control of the data bus to the first client device before the second client device, if the first memory address is required to be accessed to execute the first memory operation.

5. The method of claim 2, wherein the providing control of the data bus comprises, if the first memory operation request occurs after the second memory operation request and if the first memory address is required to be accessed to execute the first memory operation, relinquishing control of the data bus from the second client device to the first client device.

6. The method of claim 5, wherein the relinquishing control of the data bus comprises re-establishing control of the data bus to the second client device after the first memory operation is complete.

7. The method of claim 1, wherein the memory device comprises a Dynamic Random Access Memory (DRAM) device with an upper-half plurality of memory banks and a lower-half plurality of memory banks, and wherein the partitioning of the one or more banks comprises associating the first set of memory banks with the upper-half plurality of memory banks in the DRAM device and associating the second set of memory banks with the lower-half of memory banks in the DRAM device.

8. The method of claim 1, wherein the configuring access to the first plurality of memory cells comprises mapping one or more physical address spaces within the first set of memory banks to one or more respective memory buffers associated with the first client device.

9. The method of claim 1, wherein the configuring access to the second plurality of memory cells comprises mapping one or more physical address spaces within the second set of memory banks to one or more respective memory buffers associated with the second client device.

10. A computer program product comprising a computer-usable medium having computer program logic recorded thereon that, when executed by one or more processors, accesses a memory device in a computer system with a plurality of client devices, the computer program logic comprising:
first computer readable program code that enables a processor to partition one or more memory banks of the memory device into a first set of memory banks and a second set of memory banks;
second computer readable program code that enables a processor to configure access to a first plurality of memory cells within the first set of memory banks, wherein the first plurality of memory cells is associated with a first memory operation of a first client device; and
third computer readable program code that enables a processor to configure access to a second plurality of memory cells within the second set of memory banks, wherein the second plurality of memory cells is associated with a second memory operations of a second client device.

11. The computer program product of claim 10, the computer program logic further comprising:
fourth computer readable program code that enables a processor to access, via a data bus coupling the first and second client devices to the memory device, the first set of memory banks when the first memory operation is requested by the first client device, wherein a first memory address from the first set of memory banks is associated with the first memory operation;
fifth computer readable program code that enables a processor to access, via the data bus, the second set of memory banks when the second memory operation is requested by the second client device, wherein a second memory address from the second set of memory banks is associated with the second memory operation; and
sixth computer readable program code that enables a processor to provide control of the data bus to the first client device or the second client device during the first memory operation or second memory operation, respectively, based on whether the first memory address or the second memory address is accessed to execute the first or second memory operation.

12. The computer program product of claim 11, wherein the data bus has a predetermined bus width, and wherein the sixth computer readable program code comprises:
seventh computer readable program code that enables a processor to transfer data between the first client device, or the second client device, and the memory device using the entire bus width of the data bus.

13. The computer program product of claim 12, wherein the sixth computer readable program code comprises:
seventh computer readable program code that enables a processor to provide control of the data bus to the first client device before the second client device, if the first memory address is required to be accessed to execute the first memory operation.

14. The computer program product of claim 12, wherein the sixth computer readable program code comprises:
seventh computer readable program code that enables a processor to, if the first memory operation request occurs after the second memory operation request and if the first memory address is required to be accessed to execute the first memory operation, relinquish control of the data bus from the second client device to the first client device.

15. The computer program product of claim 14, wherein the seventh computer readable program code comprises:
eighth computer readable program code that enables a processor to re-establish control of the data bus to the second client device after the first memory operation is complete.

16. The computer program product of claim 10, wherein the memory device comprises a Dynamic Random Access Memory (DRAM) device with an upper-half plurality of memory banks and a lower-half plurality of memory banks, and wherein the first computer readable program code comprises:
seventh computer readable program code that enables a processor to associate the first set of memory banks with the upper-half plurality of memory banks in the DRAM device and associating the second set of memory banks with the lower-half of memory banks in the DRAM device.

17. The computer program product of claim 10, wherein the second computer readable program code comprises:
seventh computer readable program code that enables a processor to map one or more physical address spaces within the first set of memory banks to one or more respective memory buffers associated with the first client device.

18. The computer program product of claim 10, wherein the third computer readable program code comprises:
seventh computer readable program code that enables a processor to map one or more physical address spaces within the second set of memory banks to one or more respective memory buffers associated with the second client device.

19. A computer system comprising:
a first client device;
a second client device;
a memory device with one or more memory banks partitioned into a first set of memory banks and a second set of memory banks, wherein:
a first plurality of memory cells within the first set of memory banks configured to be accessed by a first memory operation associated with the first client device; and
a second plurality of memory cells within the second set of memory banks configured to be accessed by a second memory operation associated with the second client device; and
a memory controller configured to control access between the first client device and the first plurality of memory cells and to control access between the second client device and the second plurality of memory cells.

20. The computing system of claim 19, wherein the first and second client devices comprise at least one of a central processing unit, a graphics processing unit, and an application-specific integrated circuit.

21. The computing system of claim 19, wherein the memory device comprises a Dynamic Random Access Memory (DRAM) device with an upper-half plurality of memory banks and a lower-half plurality of memory banks, the first set of memory banks associated with the upper-half plurality of memory banks in the DRAM device and the second set of memory banks associated with the lower-half of memory banks in the DRAM device.

22. The computing system of claim 19, wherein the memory device comprises one or more physical address spaces within the first set of memory banks mapped to one or more respective memory operations associated with the first client device.

23. The computing system of claim 19, wherein the memory device comprises one or more physical address spaces within the second set of memory banks mapped to one or more respective memory operations associated with the second client device.

24. The computing system of claim 19, wherein the memory controller is configured to:
access, via a data bus coupling the first and second client devices to the memory device, the first set of memory banks when the first memory operation is requested by the first client device, wherein a first memory address from the first set of memory banks is associated with the first memory operation;
access, via the data bus, the second set of memory banks when the second memory operation is requested by the second client device, wherein a second memory address from the second set of memory banks is associated with the second memory operation; and
provide control of the data bus to the first client device or the second client device during the first memory operation or second memory operation, respectively, based on whether the first memory address or the second memory address is accessed to execute the first or second memory operation

25. The computing system of claim 24, wherein the data bus has a predetermined bus width, and wherein the memory controller is configured to control a transfer of data between the first client device, or the second client device, and the memory device using the entire bus width of the data bus.

26. The computing system of claim 24, wherein the memory controller is configured to provide control of the data bus to the first client device before the second client device, if the first memory address is required to be accessed to execute the first memory operation.

27. The computing system of claim 24, wherein the memory controller is configured to, if the first memory operation request occurs after the second memory operation request and if the first memory address is required to be accessed to execute the first memory operation, relinquish control of the data bus from the second client device to the first client device.

28. The computing system of claim 27, wherein the memory controller is configured to re-establish control of the data bus to the second client device after the first memory operation is complete.
